(19) United States
(12) Patent Application Publication
(10) Pub. No.: US 2020/0369161 A1
(43) Pub. Date: Nov. 26, 2020

(54) ELECTRICAL VEHICULAR SYSTEM FOR POWERING A SEMI-TRAILER TRUCK WITH SOLAR ENERGY

(71) Applicant: Edward Lee, Costa Mesa, CA (US)

(72) Inventor: Edward Lee, Costa Mesa, CA (US)

(21) Appl. No.: 16/421,292

(22) Filed: May 23, 2019

(51) Int. Cl. B60L 8/00; B62D 65/14; B60K 7/00

(52) U.S. Cl. CPC B60L 8/003; B62D 53/06; B60K 7/0007; B62D 65/14

(57) ABSTRACT

An electrical vehicular system for powering a semi-trailer truck provides a tractor unit and semi-trailers detachably coupled together with a trailer hitch connector. The tractor unit has a scalable chassis equipped with interchangeable body components that easily attach and detach to change appearance and functionality of the tractor unit and semi-trailers. A rear hitch platform on the tractor unit couples to, and hauls the semi-trailers. The tractor and semi-trailers are electrically powered through an arrangement of solar cell assemblies that recharge batteries in the wheel hubs of the tractor and/or semi-trailers. The solar cell assemblies operate on the tractor roof, sidewalls, and trailer roof. The tractor unit has an interior tractor cabin that forms a customizable center driving position for increased visibility, a sleeping portion for sleeping, and a living portion for operating and entertaining. A computer and a software program control operation and charging of tractor unit.

### FIELD OF THE INVENTION

The present invention relates generally to an electrical vehicular system for powering a semi-trailer truck with solar energy. More so, the present invention relates to a vehicular system that provides a tractor unit and one or more semi-trailers detachably coupled together with a trailer hitch connector, such that the tractor unit and the semi-trailers are operable together, or independently of each other; whereby the tractor unit has a scalable chassis equipped with interchangeable body components that easily attach and detach to change appearance and functionality of the tractor unit and semi-trailers; whereby a rear hitch platform 122 on the tractor unit couples to, and hauls the semi-trailers; whereby the tractor and semi-trailers are electrically powered through an arrangement of solar cell assemblies that recharge batteries in the wheel hubs of the tractor and/or semi-trailers; whereby the solar cell assemblies operate on the tractor roof, sidewalls, and trailer roof; whereby the tractor unit has an interior tractor cabin that forms a customizable center driving position for increased visibility, a sleeping portion for sleeping on long hauls, and a living portion for operating and entertaining; and whereby a computer, digital display screen, and software program control operation and charging of tractor unit

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known in the art that there are about 2.8 million semi-trucks, or tractors, registered in the U.S. as of 2019. The trucks hitch to semi-trailers that have no front wheels and can be used only when connected to the tractor part of the truck. Their brakes are automatically applied when the trailer is standing unattached. Only when a truck is connected, and pressure from the truck's engine-powered air pump releases the brakes, can the trailer roll. Attempts at electrification of the semi-trucks is in its nascent stages.

Generally, electrical vehicles operate on battery power that is charged through charging stations and external power units. The electrical vehicles does not use an internal combustion engine alone or in combination with a battery to form a hybrid system. Often, a communication interface system is included in the electric vehicle to provide a complete plug since the electric vehicle relies exclusively on battery power to propel the vehicle is needed.

The rechargeable batteries that supply driving power to the electric vehicle form a considerable amount of the space and weight of the total vehicular weight and bulk, thereby restricting transport capacity of the vehicle which would be otherwise left available. Also, it is known in the art that the cattery capacity determines the driving range of the vehicle. Further, in recharging drained batteries, it becomes obligatory that the electric vehicle be rendered immobile for several hours on the average. This traditionally requires a stationary charging point, which may not always be available.

Other proposals have involved electrical vehicular systems. The problem with these vehicles is that they do not power larger trucks, such as semi-truck units. Also, they do not have an attachable semi-trailer that is also powered by solar energy, like the tractor unit. Even though the above cited electrical vehicles meet some of the needs of the market, an electrical vehicular system for powering a semi-trailer truck with solar energy, is still desired.

### SUMMARY

Illustrative embodiments of the disclosure are generally directed to an electrical vehicular system for powering a semi-trailer truck with solar energy. The electrical vehicular system provides a tractor unit and one or more semi-trailers detachably coupled together with a trailer hitch connector. The tractor unit and the semi-trailers are operable together, or independently of each other.

The tractor unit and the semi-trailer truck are defined by a scalable chassis that can be equipped with interchangeable body components that easily attach and detach to change the appearance and functionality of the tractor unit and the semi-trailers. In one embodiment, the tractor unit includes a rear hitch platform that is capable to haul an additional trailer or any storage structure with wheels. The semi-trailer may be motorized or non-motorized.

The tractor unit and the semi-trailers are electrically powered through a unique arrangement of solar cell assemblies. The electrical vehicular system is 100% electrical, whereby the solar cell assemblies may include a photovoltaic solar panel that converts solar energy to electricity that charges a battery of the tractor unit and/or the semi-trailers. The battery powers the operation of hub motors in the tractor wheels and/or the trailer wheels. Further, the electrical vehicular system provides convenient electrical charging means for the truck through a charging trailer that attaches to the truck, and/or at least one solar cell assembly on the roof, bed, or trailer of the truck. The system may utilize regenerative braking to decelerate.

In some embodiments, the tractor unit has a unique interior tractor cabin that is designed to be a customizable space, similar to a home interior. The interior tractor cabin is defined by a modular driving portion with a center driving position for increased visibility, a sleeping portion for sleeping on long hauls, and a living portion for operating the tractor unit and the semi-trailers for entertaining.

The driver or passenger to customize and integrate ornamental features, furniture, lighting elements, computer devices, technology, connectivity, and entertainment systems in the interior tractor cabin. The interior tractor cabin comprises a center driving position. The center driving position is characterized by a central position of the interior tractor cabin that enhances driving visibility and tractor unit position awareness.

In one aspect, the electrical vehicular system for powering a semi-trailer truck with solar energy, comprises:

a tractor unit having:
a tractor chassis comprising multiple steerable front tractor wheels and multiple rear tractor wheels operable with a tractor wheel hub assembly, a tractor roof, a tractor sidewall, a pair of doors;
a rear hitch platform;
at least one tractor hub motor operational with the tractor wheel hub assembly, each tractor hub motor operational to drive a respective tractor wheel;
a tractor battery operatively connected to the tractor hub motor;
at least one tractor solar cell assembly disposed on the tractor roof, or the tractor sidewall or both, the tractor solar cell assembly being operatively connected to the tractor battery for recharging the tractor battery;
an interior tractor cabin defined by a center driving position, a sleeping portion, a living portion, a steering member operatively connected to the tractor wheel hub assembly, an illumination portion, at least one seat, at least one communication interface, and a computer having a software program;
whereby the software program is operational to control at least one of the following: the tractor hub motor, the illumination portion, the tractor battery, the tractor solar cell assembly, and the communication interface; and
   one or more semi-trailers detachably coupled to the tractor unit through a trailer hitch connector, the semi-trailers having:
a trailer chassis comprising multiple trailer wheels operable with a trailer wheel hub assembly, a trailer roof, and a trailer sidewall;
at least one trailer hub motor operational to drive a respective trailer wheel;
a trailer battery operatively connected to the trailer hub motor;
at least one trailer solar cell assembly disposed on the trailer roof, or the trailer sidewall or both, the trailer solar cell assembly being operatively connected to the trailer battery for recharging the trailer battery.

In another aspect, the rear hitch platform is operable to haul the semi-trailers or a storage structure with wheels.

In another aspect, the tractor hub motor is encompassed inside at least one of the tractor wheels.

In another aspect, the trailer hub motor is encompassed inside at least one of the trailer wheels.

In another aspect, the system further comprises a regenerative electric braking circuit.

In another aspect, the electric braking circuit is operatively connected to the tractor hub motor, whereby the electric braking circuit causes electric braking of the tractor wheels, or the trailer wheels, or both, whereby the hub motor generates a back electromotive force that feeds the tractor battery, or the trailer battery, or both.

In another aspect, the front and rear tractor wheels, and the trailer wheels comprise eighteen wheels.

In another aspect, the rear hitch platform forms a hitch coupling hole.

In another aspect, the semi-trailers forms a hitch that detachably couples to the hitch coupling hole.

In another aspect, the sleeping portion of the interior tractor cabin comprises a bed.

In another aspect, the at least one seat of the interior tractor cabin comprises one seat.

In another aspect, the tractor roof is defined by a curved shape.

In another aspect, the tractor solar cell assembly and the trailer solar cell assembly comprises a photovoltaic solar panel.

One objective of the present invention is to create a clean energy semi-truck rig that emits zero emissions.

Another objective is to provide a modular tractor unit with interchangeable body components.

Another objective is to power the tractor unit with solar cell assemblies on the tractor roof and on a semi-trailer roof

Yet another objective is to allow the driver to sit in a central position in the interior tractor cabin to enhance viewing the environment around the tractor unit and the semi-trailers.

Yet another objective is to allow the interior tractor cabin to be customizable, similar to a home or office interior.

Yet another objective is to provide an interchangeable with an open storage bed that can receive additional wheels.

Yet another objective is to provide an inexpensive to manufacture electrical vehicular system for powering a semi-trailer truck with solar energy.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary electrical vehicular system for powering a semi-trailer truck with solar energy, in accordance with an embodiment of the present invention;

FIG. 2 illustrates a left side perspective view of an exemplary tractor unit, in accordance with an embodiment of the present invention;

FIG. 3 illustrates a right side perspective view of the tractor unit, in accordance with an embodiment of the present invention;

FIG. 4 illustrates a top perspective view of the tractor unit, showing the rear hitch platform, in accordance with an embodiment of the present invention;

FIG. 5 illustrates a bottom perspective view of the tractor unit, showing the rear hitch platform, in accordance with an embodiment of the present invention;

FIG. 6 illustrates a frontal view of the tractor unit hitched to a semi-trailer, showing the rear hitch platform, in accordance with an embodiment of the present invention;

FIG. 7 illustrates a rear view of the tractor unit hitched to a semi-trailer, showing the rear hitch platform, in accordance with an embodiment of the present invention;

FIG. 8 illustrates a right side perspective view of an interior tractor cabin of the tractor unit, showing the seat, illumination portion, communication device, steering member, and computer, in accordance with an embodiment of the present invention;

FIG. 9 illustrates a perspective view of the interior tractor cabin of the tractor unit, showing the sleeping portion, in accordance with an embodiment of the present invention;

FIG. 10 illustrates multiple perspective views of an exemplary electrical vehicular system for powering a semi-trailer truck having a long front tractor unit portion and a short rear hitch platform with four wheels, in accordance with an embodiment of the present invention;

FIG. 11 illustrates multiple perspective views of an exemplary electrical vehicular system for powering a semi-trailer truck having a short front tractor unit portion and a long rear hitch platform with four wheels, in accordance with an embodiment of the present invention;

FIG. 12 illustrates multiple perspective views of an exemplary electrical vehicular system for powering a semi-trailer truck having a short front tractor unit portion and a long rear hitch platform with two wheels, in accordance with an embodiment of the present invention; and

FIG. 13 illustrates side views of two electrical vehicular systems having interchangeable rear compartments, interchangeable powertrain and chassis, and interchangeable recharging sources, in accordance with an embodiment of the present invention.

Like reference numerals refer to like parts throughout the various views of the drawings.

### DETAILED DESCRIPTION OF THE INVENTION

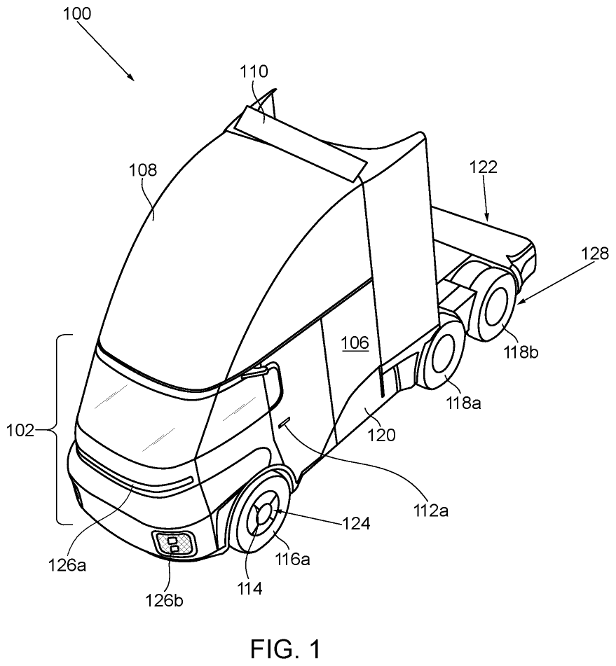

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

An electrical vehicular system 100 for powering a semi-trailer truck with solar energy is referenced in FIGS. 1-13. The electrical vehicular system 100 provides a tractor unit 102 and one or more semi-trailers 600 that are independently or jointly powered by solar energy, and detachably coupled together with a trailer hitch connector. The tractor unit 102 is powered by at least one tractor solar cell assembly 110, and has a reconfigurable body chassis that can adapt to receive interchangeable modular body components. Similarly, the attached semi-trailers 600 are powered by at least one trailer solar cell assembly, or may be operatively attached to the solar energy assembly of the tractor unit 102 for tethered connectivity.

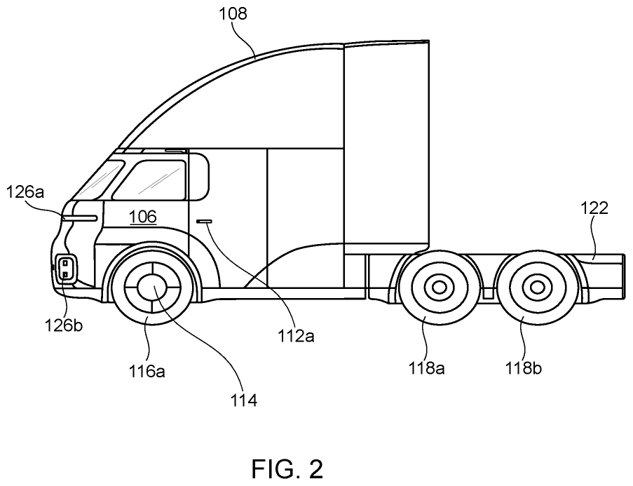

As FIG. 2 references, the tractor unit 102 comprises a tractor chassis 104. The tractor chassis 104 forms the base frame of the tractor unit 102. The exterior and interior layout, structure, architecture is modifiable. The tractor chassis 104 is created to be scalable in order to easily modify the structure to create different shapes, sizes, and types of vehicles as well as integrate various powertrain systems, charging methods, and technology.

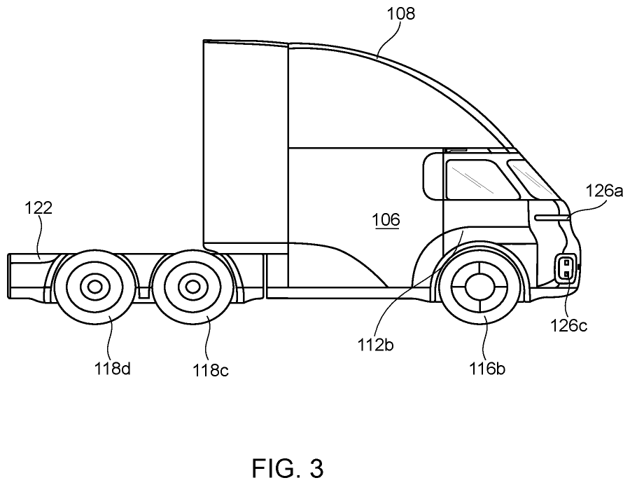

In some embodiments, the tractor chassis 104 is defined by rounded rectangular and or square shapes and or structures represented by four sides connected by rounded corners (FIG. 3). Additionally, the tractor unit 102 is unique with a cab forward design, further characterized by a continuous tractor compartment profile defined by a short hood length, raked front windshield. This unique configuration creates a harmonized hood to tractor compartment profile. Furthermore, the driver position is near or above front wheel axle allowing for increased rear passenger and rear storage space.

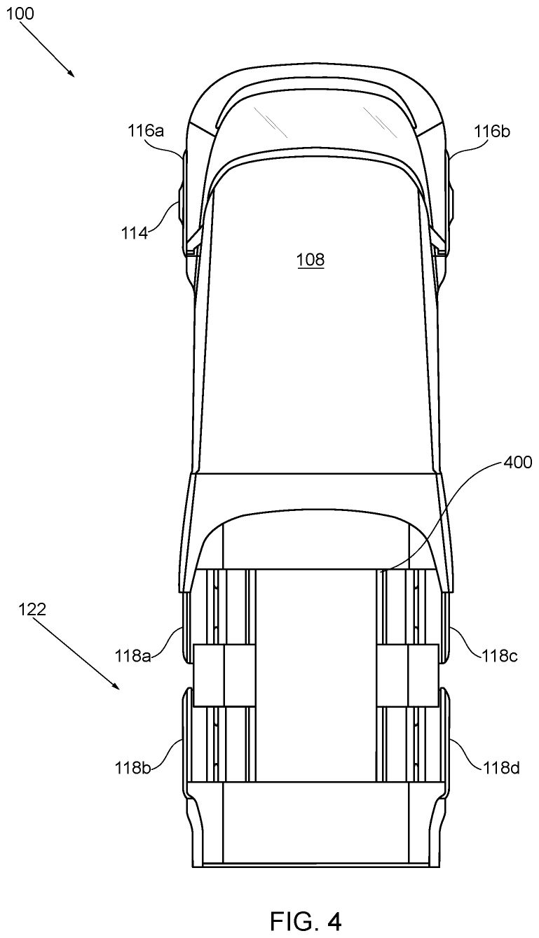

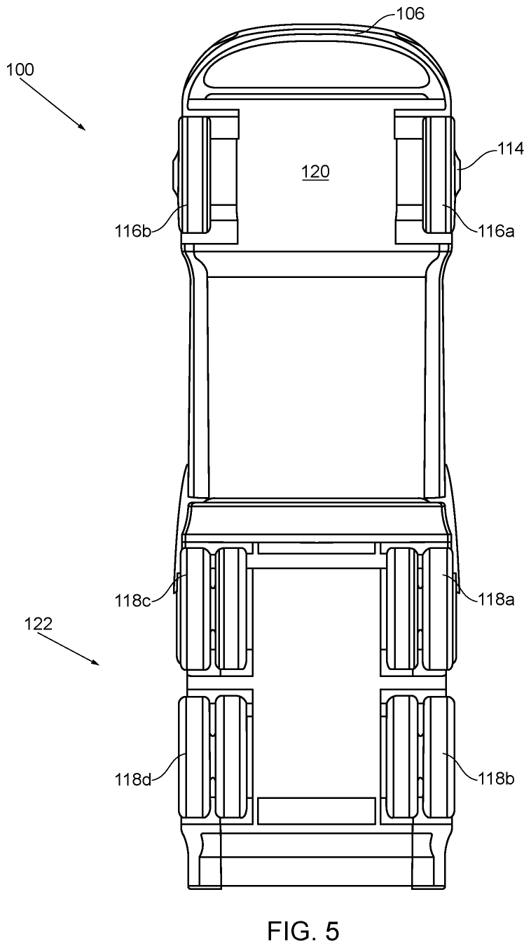

As referenced in FIGS. 4 and 5, the tractor chassis 104 includes a rear hitch platform 122 that is capable to haul an additional trailer or any storage structure with wheels. The rear hitch platform forms a hitch coupling hole 400 for hitching functions with the semi-trailers 600. Such a multi-task platform changes the purpose and function of the tractor unit 102, allowing for multiple task, such as: sanitation, postal delivery, delivery of service and goods, cargo transport, mobile home, and food service.

The tractor chassis 104 includes a tractor roof 108. In one non-limiting embodiment, the tractor roof 108 is defined by a curved shape. The tractor roof 108 may house at least one tractor solar cell assembly 110 for charging a tractor battery 120 simultaneous while driving or stationary in parked position. The tractor chassis 104 comprises multiple steerable front tractor wheels 116a, 116b and multiple rear tractor wheels 118a, 118b, 118c, 118d operable with a tractor wheel hub assembly 124. The tractor chassis 104 also includes a tractor sidewall 106 and a pair of doors 112a, 112b that enable passage to an interior tractor cabin, described below.

Looking back at FIG. 1, the electrical vehicular system 100 provides at least one tractor hub motor 114 that is operational with any of the aforementioned tractor wheels 116a-b, 118a-d. The tractor hub motor 114 operational with the tractor wheel hub assembly 124. Each tractor hub motor 114 is operational to drive a respective tractor wheel 116a-b, 118a-d. The tractor hub motor 114 is encompassed inside at least one of the tractor wheels 116a-b, 118a-d. Each tractor hub motor 114 is operational to drive a respective tractor wheel.

In one embodiment, the tractor hub motor 114 is encompassed and operational inside the front tractor wheels 116a, 116b. In another embodiment, the tractor hub motor 114 is encompassed and operational the front and rear tractor wheels 118a, 118b, 118c, 118d, creating an all-wheel drive tractor unit. In one non-limiting embodiment, the tractor hub motor 114 has a coil that generates electromagnetic fields that are supplied to a stationary windings of the tractor hub motor 114. As is known in the art, the outer part of the tractor hub motor 114 follows, or tries to follow, those fields, turning the attached wheel.

For powering the tractor unit 102, the electrical vehicular system 100 provides a tractor battery 120 that operatively connects to the tractor hub motor 114. Those skilled in the art will recognize that electric-vehicle batteries differ from starting, lighting, and ignition (SLI) batteries because they are designed to give power over sustained periods of time. Deep-cycle batteries are used instead of SLI batteries for the electric truck system 100. The battery may include, without limitation, a lead-acid battery, a nickel metal hydride, a lithium-ion battery.

The solar cell assembly charges the tractor battery 120 while it is connected to the tractor hub motor 114 in the tractor wheels. The tractor solar cell assembly 110 absorbs sunlight as a source of energy to generate electricity. The tractor solar cell assembly 110 is operational on the tractor roof 108 and/or the tractor sidewall 106. FIG. 1 shows a tractor solar cell assembly 110 traversing the tractor roof 108 of the tractor unit 102. However it is significant to note that any combination of positions for solar cell assembly may be used on the tractor unit 102. The tractor solar cell assembly 110 is operatively connected to the tractor battery 120 for recharging the tractor battery 120. In some embodiments, the tractor solar cell assembly 110 is a photovoltaic solar panel, known in the art.

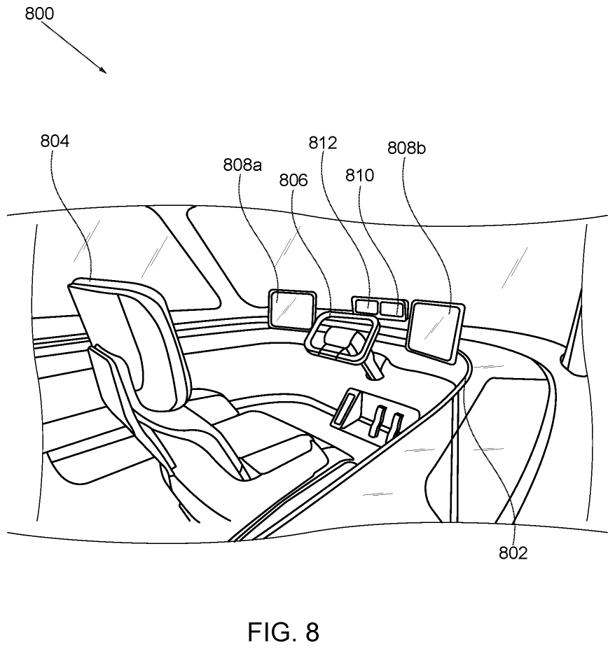

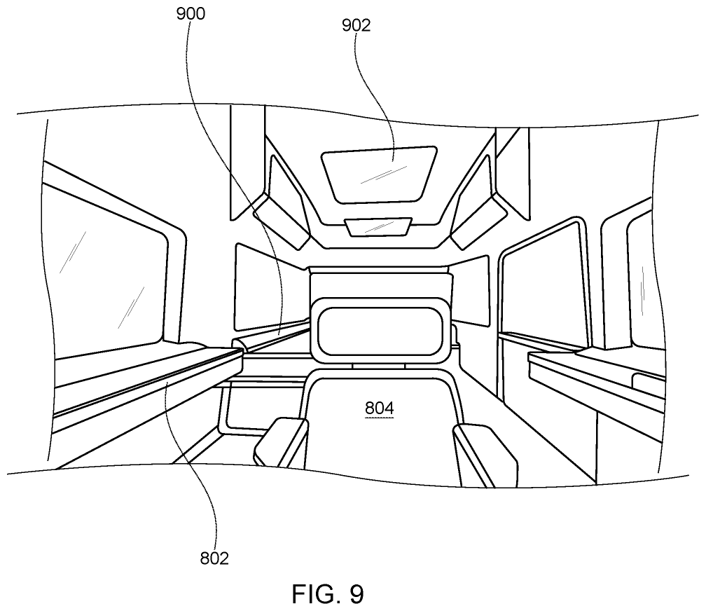

As referenced in FIGS. 8 and 9, the tractor unit 102 has a unique interior design that is state-of-the-art for the comfort of the driver, and efficient operation of the electrical vehicular system 100. Thus, as shown in the right side rear view of FIG. 8. The driver and passenger are provided with a quiet and comfortable living space with tools to accommodate long hours of driving. Due to the fact that the interior tractor cabin 800 is designed to be like a home, the space is specifically able to integrate any additional technology that the user desires which includes but not limited to mobile phones, tablet, computer, internet, entertainment system 100.

The interior tractor cabin 800 is defined by a center driving position that allows the driver to see the area around the tractor unit 102 and the semi-trailers, more effectively. Continuing with the interior tractor cabin 800, at least one seat 804 provides a position for the driver in the center driving position. The center driving position of the seat is characterized by the driver sitting in a central position of the interior tractor cabin 800, for increased visibility and non-biased awareness of truck position. In one non-limiting embodiment, the at least one seat 804 comprises only one seat. However additional seats can be used in other embodiments, the seat 804 is height adjustable, and swivels for optimal comfort to the driver.

A steering member 806 operatively connects to the tractor wheel hub assembly. The interior tractor cabin 800 also include a steering member 806 operatively connected to the front tractor wheels 116a, 116b for steering thereof. As illustrated in FIG. 9, a sleeping portion 900 is located in the rear of the interior tractor cabin 800 comprises. The sleeping portion 900 may include a bed and a night light 902. Those skilled in the art will recognize that a truck driver on a long haul requires sleeping accommodations, since the number of driving hours is regulated.

Both the outer sidewall 106 and the interior tractor cabin 800 of the tractor unit also includes an illumination portion 126a, 126b, 126c that illuminates the exterior, and an illumination portion 802 that lights up the dashboard. In one embodiment, the illumination portion 126a-c, 802 comprises a horizontal lighting architecture. The outer an illumination portion 126a generates a horizontal beam of light that harmonizes the lower and upper body while creating a strong foundation of stability. The illumination portion also includes a pair of headlight 126b, 126c used for lighting the path ahead of the tractor unit. In other embodiments, a radio and a speaker system 812 may also be available in the interior tractor cabin 800 for entertainment and communication purposes.

In some embodiments, the interior tractor cabin 800 also includes at least one communication interface 808a, 808b. The interior tractor cabin 800 also includes a computer 810 having a software program. The software program is operational to control at least one of the following: the tractor hub motor 114, the illumination portion, the tractor battery 120, the tractor solar cell assembly 110, and the communication interface.

The communication interface 808a-b may be a touch screen that allows the driver to control aspects of the electric truck, such as remote control, braking capacity, entertainment, and other driving related functions. In this manner, the interior tractor cabin 800 contributes positively to humanity through automotive innovation by mobilizing the flexibility and convenience that is not provided in present combustion or electric vehicles.

The software program may utilize tracking components and software known in the art, i.e., GPS, towers, etc. The programmable aspects of the electronic vehicular system 100 are configurable to expand/upgrade software and hardware to integrate various technologies to support performance, safety, and convenience such as autonomous driving and have the ability to provide various functions fit for the user and/or infrastructure.

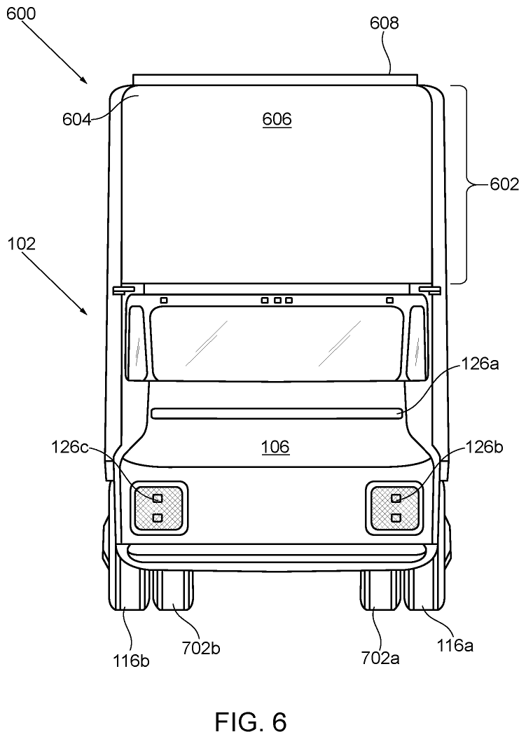

Turning now to FIG. 6, the electrical vehicular system 100 further provides one or more semi-trailers 600 that detachably coupled to the tractor unit 102 through a trailer hitch connector. The semi-trailers 600 forms a hitch 712 that detachably couples to the hitch coupling hole 400. The semi-trailers 600 can follow the tractor chassis 104 in a tethered, wireless, or autonomous configuration. In some embodiments, the semi-trailers 600 may be used to carry people, animals, and supplies. The semi-trailers 600 is adapted to receive and orient at least one of the trailer solar cell assembly 608 for generating electricity for the tractor battery 120, and a trailer battery.

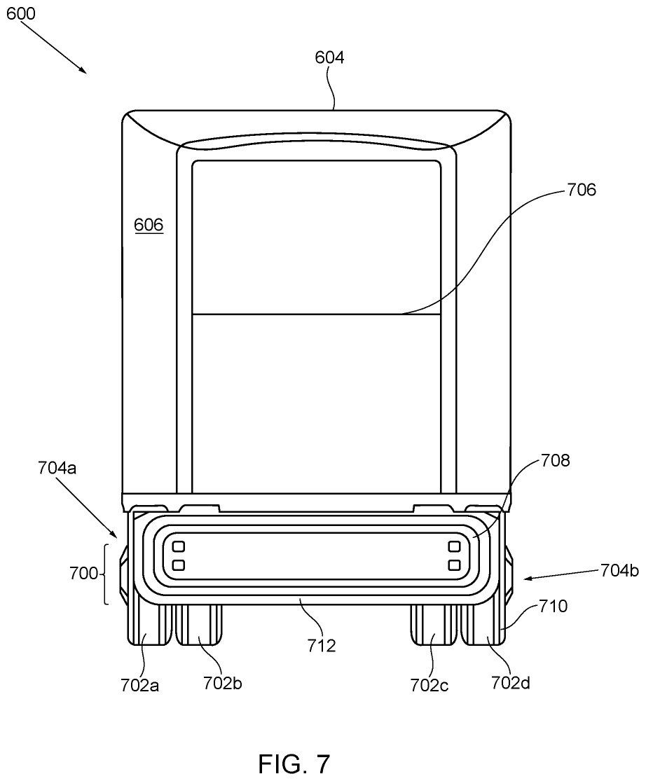

As FIG. 7 shows, the semi-trailers 600 comprises a trailer chassis 602 comprising multiple trailer wheels 702a-d. In some embodiments, the semi-trailers 600 may be motorized or non-motorized. Multiple semi-trailers may operate in conjunction, or independently of each other. The semi-trailers 600 is in a shape of a rectangular structure that can be upgraded further with autonomous technology, converting into an autonomous rectangular vehicle. The semi-trailers 600 can be used as a living space such as a home or for various outdoor activities such as camping and provides an enclosed shelter for sleep during travel. The space can be customized for various purposes such as a food truck, delivery vehicle, locker for storage/goods, merchandise pop-up store.

In one embodiment, the trailer chassis 602 is operable with a trailer wheel hub assembly 700, a trailer roof 604, and a trailer sidewall 606. A trailer gate 706 allows access to the interior cavity of the semi-trailer 600, where items are stored and carried. A trailer rear light 708 provides signaling lights from the rear. Multiple trailer wheels 702a, 702b, 702c, 702d support the trailer chassis 602, and similar to the tractor wheels 116a-b, 118a-d, may operate through solar energy. In one non-limiting embodiment, the tractor wheels 116a-b, 118a-d, and the trailer wheels 702a-d comprise eighteen wheels. Though in other embodiments, more or less than eighteen wheels may be used.

In operational connection with the trailer wheels 702a-d, is at least one trailer hub motor 704a, 704b. The trailer hub motor 704a-b is operational to drive a respective trailer wheel. The trailer hub motor is encompassed inside at least one of the trailer wheels. In some embodiments, a trailer battery 710 operatively connects to the trailer hub motor 704a-b. The semi-trailers 600 may have a rechargeable tractor battery 710 that are charged from at least one trailer solar cell assembly, or one of the at least one trailer solar cell assemblies 608 on the tractor roof 108 or rear open bed of the tractor unit 102. A trailer hub motor 704a, 704b on each trailer wheel 702a-d connects with the trailer batteries in the semi-trailers 600.

For charging the trailer battery 706, the semi-trailers 600 comprise at least one trailer solar cell assembly 608 that is disposed on the trailer roof 604, or the trailer sidewall 606. The trailer solar cell assembly 608 is operatively connected to the trailer battery for recharging the trailer battery. In one non-limiting embodiment, the trailer solar cell assembly is a photovoltaic solar panel. In some embodiments, the electrical vehicular system 100 further comprises a regenerative electric braking circuit 128. The electric braking circuit is operatively connected to the tractor hub motor 114, whereby the electric braking circuit causes electric braking of the tractor wheels, or the trailer wheels, or both, whereby the hub motor generates a back electromotive force that feeds the tractor battery 120, or the trailer battery, or both.

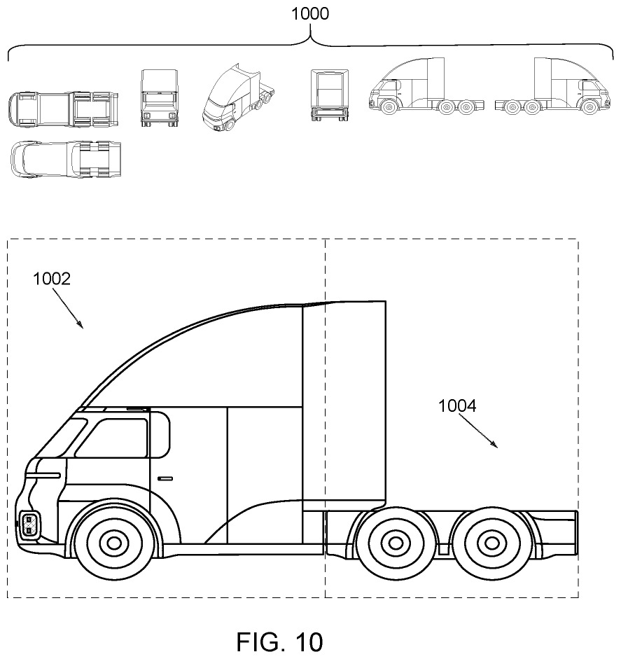

As discussed above, the semi-trailers comprise a trailer chassis of different lengths and functions, different types of recharging means, and different numbers of wheels. For example, FIG. 10 illustrates multiple perspective views of an exemplary electrical vehicular system for powering a semi-trailer truck 1000 having a long front tractor unit 1002 and a short rear hitch platform 1004 with four wheels. The views shown include a frontal view, a top view, a side view, an isometric view, and a rear view of the semi-trailer truck 1000.

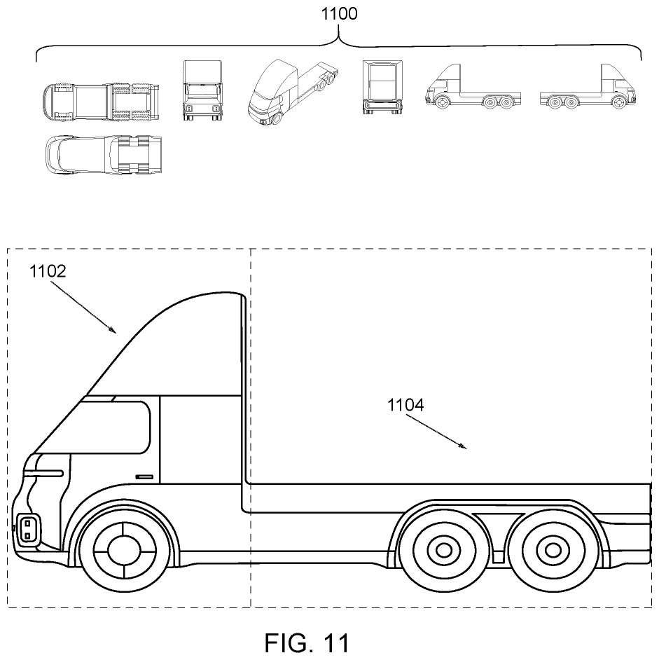

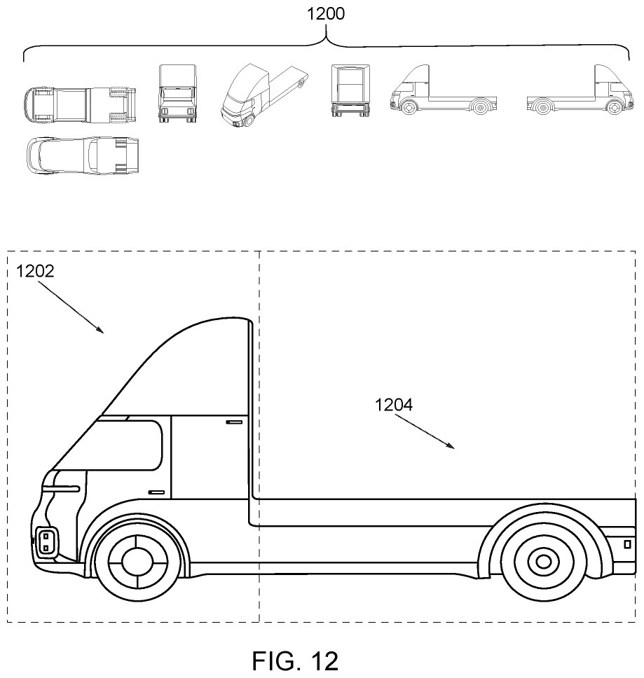

Continuing with another embodiment, FIG. 11 illustrates multiple perspective views of an exemplary electrical vehicular system for powering a semi-trailer truck 1100 having a short front tractor unit portion 1102 and a long rear hitch platform 1104 with four wheels. In yet another embodiment, FIG. 12 illustrates multiple perspective views of an exemplary electrical vehicular system for powering a semi-trailer truck 1200 having a short front tractor unit portion 1202 and a long rear hitch platform 1204 with two wheels.

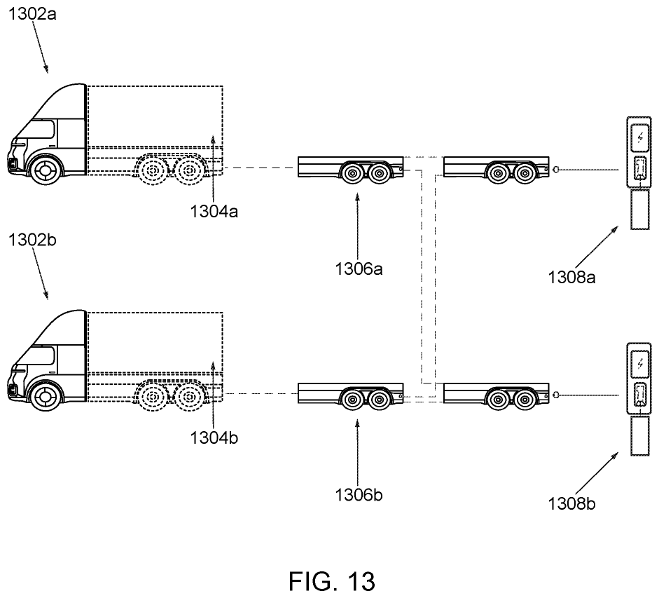

The system 100 also provides unique interchangeable components. For example, FIG. 13 references two semi-trucks side-by-side and their differences in interchangeable components. The two electrical vehicular systems 1302a, 1302b each have interchangeable rear compartments 1304a, 1304b, interchangeable powertrain and chassis 1306a, 1306b, and interchangeable recharging sources 1308a, 1308b. The capacity to interchange the type of charging mechanisms is also shown. Semi-truck 1300a is charged with a battery 1308a, while semi-truck 1300b is charged with a fuel cell 1308b.

In conclusion, the electrical vehicular system 100 is configured to power the semi-trailer truck provides a tractor unit 102 and semi-trailers 600 detachably coupled together with a trailer hitch connector. The tractor unit 102 has a scalable chassis equipped with interchangeable body components that easily attach and detach to change appearance and functionality of the tractor unit 102 and semi-trailers 600.

A rear hitch platform 122 on the tractor unit 102 couples to, and hauls the semi-trailers 600. The tractor and semi-trailers 600 are electrically powered through an arrangement of solar cell assemblies that recharge batteries in the wheel hubs of the tractor and/or semi-trailers 600. The solar cell assemblies operate on the tractor roof 108, sidewalls, and trailer roof. The tractor unit 102 has an interior tractor cabin that forms a customizable center driving position for increased visibility, a sleeping portion for sleeping, and a living portion for operating and entertaining. A computer and a software program control operation and charging of tractor unit 102.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. An electrical vehicular system for powering a semi-trailer truck with solar energy, the system comprising:
a tractor unit having:
a tractor chassis comprising multiple steerable front tractor wheels and multiple rear tractor wheels operable with a tractor wheel hub assembly, a tractor roof, a tractor sidewall, a pair of doors;
at least one tractor hub motor operational with the tractor wheel hub assembly, each tractor hub motor operational to drive a respective tractor wheel;
a tractor battery operatively connected to the tractor hub motor;
at least one tractor solar cell assembly disposed on the tractor roof, or the tractor sidewall or both, the tractor solar cell assembly being operatively connected to the tractor battery for recharging the tractor battery;
an interior tractor cabin defined by a center driving position, a sleeping portion, a living portion, a steering member operatively connected to the tractor wheel hub assembly, an illumination portion, at least one seat, at least one communication interface, and a computer having a software program;
whereby the software program is operational to control at least one of the following: the tractor hub motor, the illumination portion, the tractor battery, the tractor solar cell assembly, and the communication interface; and
one or more semi-trailers detachably coupled to the tractor unit, the semi-trailers having:
a trailer chassis comprising multiple trailer wheels operable with a trailer wheel hub assembly, a trailer roof, and a trailer sidewall;
at least one trailer hub motor operational to drive a respective trailer wheel;
a trailer battery operatively connected to the trailer hub motor;
at least one trailer solar cell assembly disposed on the trailer roof, or the trailer sidewall or both, the trailer solar cell assembly being operatively connected to the trailer battery for recharging the trailer battery.

2. The system of claim 2, wherein the semi-trailers detachably couple to the tractor unit through a trailer hitch connector.

3. The system of claim 1, further comprising a rear hitch platform.

4. The system of claim 3, wherein the rear hitch platform is operable to haul the semi-trailers.

5. The system of claim 4, wherein the rear hitch platform forms a hitch coupling hole.

6. The system of claim 5, wherein the semi-trailers forms a hitch that detachably couples to the hitch coupling hole.

7. The system of claim 1, wherein the tractor hub motor is encompassed inside at least one of the tractor wheels.

8. The system of claim 1, wherein the trailer hub motor is encompassed inside at least one of the trailer wheels.

9. The system of claim 1, wherein the front tractor wheels, the rear tractor wheels, and the trailer wheels comprise eighteen wheels.

10. The system of claim 1, wherein the sleeping portion of the interior tractor cabin comprises a bed.

11. The system of claim 1, wherein the at least one seat of the interior tractor cabin comprises one seat.

12. The system of claim 1, wherein the tractor roof is defined by a curved shape.

13. The system of claim 1, wherein the tractor solar cell assembly and the trailer solar cell assembly comprises a photovoltaic solar panel.

14. The system of claim 1, further comprising a regenerative electric braking circuit.

15. The system of claim 14, wherein the regenerative electric braking circuit being operatively connected to the tractor hub motor, whereby the electric braking circuit causes electric braking of the tractor wheels, or the trailer wheels, or both, whereby the hub motor generates a back electromotive force that feeds the tractor battery, or the trailer battery, or both.

16. An electrical vehicular system for powering a semi-trailer truck with solar energy, the system comprising:
a tractor unit having:
a tractor chassis comprising multiple steerable front tractor wheels and multiple rear tractor wheels operable with a tractor wheel hub assembly, a tractor roof, a tractor sidewall, a pair of doors;
a rear hitch platform;
at least one tractor hub motor encompassed inside the tractor wheel hub assembly, each tractor hub motor operational to drive a respective tractor wheel;
a tractor battery operatively connected to the tractor hub motor;
at least one tractor solar cell assembly disposed on the tractor roof, or the tractor sidewall or both, the tractor solar cell assembly being operatively connected to the tractor battery for recharging the tractor battery;
an interior tractor cabin defined by a center driving position, a sleeping portion, a living portion, a steering member operatively connected to the tractor wheel hub assembly, an illumination portion, at least one seat, at least one communication interface, and a computer having a software program;
whereby the software program is operational to control at least one of the following: the tractor hub motor, the illumination portion, the tractor battery, the tractor solar cell assembly, and the communication interface; and
one or more semi-trailers detachably coupled to the tractor unit through a trailer hitch connector, the semi-trailers having:
a trailer chassis comprising multiple trailer wheels operable with a trailer wheel hub assembly, a trailer roof, and a trailer sidewall;
at least one trailer hub motor operational to drive a respective trailer wheel;
a trailer battery operatively connected to the trailer hub motor;
at least one trailer solar cell assembly disposed on the trailer roof, or the trailer sidewall or both, the trailer solar cell assembly being operatively connected to the trailer battery for recharging the trailer battery.

17. The system of claim 16, wherein the rear hitch platform is operable to haul the semi-trailers.

18. The system of claim 16, wherein the rear hitch platform forms a hitch coupling hole.

19. The system of claim 18, wherein the semi-trailers forms a hitch that detachably couples to the hitch coupling hole.

20. An electrical vehicular system for powering a semi-trailer truck with solar energy, the system comprising:
a tractor unit having:
a tractor chassis comprising multiple steerable front tractor wheels and multiple rear tractor wheels operable with a tractor wheel hub assembly, a tractor roof defined by a curved shape, a tractor sidewall, a pair of doors;
a rear hitch platform comprising a hitch coupling hole;
at least one tractor hub motor encompassed inside the tractor wheel hub assembly, each tractor hub motor operational to drive a respective tractor wheel;
a tractor battery operatively connected to the tractor hub motor;
at least one tractor solar cell assembly disposed on the tractor roof, or the tractor sidewall or both, the tractor solar cell assembly being operatively connected to the tractor battery for recharging the tractor battery;
an interior tractor cabin defined by a center driving position, a sleeping portion, a living portion, a steering member operatively connected to the tractor wheel hub assembly, an illumination portion, at least one seat, at least one communication interface, and a computer having a software program;
whereby the software program is operational to control at least one of the following: the tractor hub motor, the illumination portion, the tractor battery, the tractor solar cell assembly, and the communication interface; and
one or more semi-trailers detachably coupled to the tractor unit through a trailer hitch connector, the semi-trailers having:
a trailer chassis comprising multiple trailer wheels operable with a trailer wheel hub assembly, a trailer roof, and a trailer sidewall;
a trailer gate;
a trailer rear light;
a hitch being detachably couplable to the hitch coupling hole formed in the rear hitch platform, whereby the rear hitch platform is operable to haul the semi-trailers;
at least one trailer hub motor operational to drive a respective trailer wheel;
a trailer battery operatively connected to the trailer hub motor;
at least one trailer solar cell assembly disposed on the trailer roof, or the trailer sidewall or both, the trailer solar cell assembly being operatively connected to the trailer battery for recharging the trailer battery;
a regenerative electric braking circuit, the regenerative electric braking circuit being operatively connected to the tractor hub motor, whereby the electric braking circuit causes electric braking of the tractor wheels, or the trailer wheels, or both, whereby the hub motor generates a back electromotive force that feeds the tractor battery, or the trailer battery, or both.
